(19) United States
(12) Patent Application Publication
(10) Pub. No.: US 2020/0080653 A1
(43) Pub. Date: Mar. 12, 2020

(54) SPRING LOAD ADJUSTING DEVICE

(71) Applicant: DENSO CORPORATION, Kariya-city (JP)

(72) Inventor: Masato UENO, Kariya-city (JP)

(21) Appl. No.: 16/562,545

(22) Filed: Sep. 6, 2019

(30) Foreign Application Priority Data
Sep. 10, 2018 (JP) 2018-168623

(51) Int. Cl. F16K 11/07

(52) U.S. Cl. CPC F16K 11/0708; F16K 11/0712

(57) ABSTRACT

An adjust screw member is screwed to a female screw member, which is formed at an axial end of a sleeve member. A spool member is movably accommodated in the sleeve member and a spring member is provided between the spool member and the adjust screw member. A swaged-claw forming portion is formed at an axial front end of the female screw member. Multiple stepped portions having different heights from one another are formed in the swaged-claw forming portion, so that an axial distance between each of the stepped portions and an axial end surface of the adjust screw member is different from one stepped portion to another stepped portion. The multiple stepped portions are arranged in a circumferential direction. One of the stepped portions is selected depending on a distance between the axial end surface of the adjust screw member and the swaged-claw forming portion. A part of the swaged-claw forming portion is plastically deformed at a position corresponding to the selected stepped portion.

### CROSS REFERENCE TO RELATED APPLICATION

This application is based on Japanese Patent Application No. 2018-168623 filed on Sep. 10, 2018, the disclosure of which is incorporated herein by reference.

### FIELD OF TECHNOLOGY

The present disclosure relates to a spring load adjusting device and a method for adjusting a spring load for a spool valve unit.

### BACKGROUND

A spool valve unit is known in the art, according to which a female screw portion is formed in a sleeve member and an adjust screw member having a male screw portion is screwed into the female screw portion of the sleeve member. A spring load adjusting device is also known in the art, according to which an axial position of the adjust screw member is adjusted to thereby adjust a spring load of a spring member movably provided in the sleeve member. When the spool valve unit is used as one of components for a hydraulic control apparatus, for example, for an automatic transmission apparatus of an automotive vehicle, a high sealing property is required between the sleeve member and the adjust screw member.

In one of the spring load adjusting devices of prior arts, an axial end of the sleeve member is swaged to an axial end surface of the adjust screw member by plastically deforming a part of the axial end of the sleeve member (a swaged portion), after the axial position of the adjust screw member relative to the sleeve member is adjusted to thereby adjust the spring load of the spring member movably provided in the sleeve member. The axial position of the adjust screw member is fixed to the sleeve member by the swaged portion and the high sealing property between the sleeve member and the adjust screw member is obtained, since the adjust screw member is pushed to the sleeve member in an axial direction thereof.

In the above prior art, it may become difficult to form the swaged portion by a proper amount of the plastic deformation, depending on the axial position of the adjust screw member relative to the sleeve member after the adjustment for the spring load. It is because the swaged portion is formed by plastically deforming the part of the axial end of the sleeve member to the axial end surface of the adjust screw member. It is, therefore, required to provide the spring load adjusting device, according to which not only the spring load can be adjusted in a wider spring load range but also the high sealing property can be obtained between the sleeve member and the adjust screw member.

### SUMMARY OF THE DISCLOSURE

The present disclosure is made in view of the above problem. It is an object of the present disclosure to provide a spring load adjusting device, according to which not only spring load can be adjusted in a wider spring load range but also high sealing property can be obtained between a sleeve member and an adjust screw member.

According to one of features of the present disclosure, an adjust screw member is screwed into a female screw member formed at an axial end of a sleeve member. A spool member is movably provided in the sleeve member and a spring member is provided in the sleeve member between the spool member and the adjust screw member, so that spring load for the spring member is adjusted by changing an axial position of the adjust screw member relative to the female screw member. A swaged-claw forming portion is formed at an axial end portion of the female screw member. A part of the swaged-claw forming portion is plastically deformed to an axial end surface of the adjust screw member so that the adjust screw member is firmly fixed to the female screw member by such a swaged portion.

Multiple stepped portions are formed in the swaged-claw forming portion and arranged in a circumferential direction of the adjust screw member. An axial distance between each stepped portion and the axial end surface of the adjust screw member is different from one another. One of the stepped portion is selected depending on an axial distance between the adjust screw member and the female screw member after adjustment for the spring load is finished. The part of the selected stepped portion is plastically deformed to form a swaged claw.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross-sectional view showing a linear solenoid valve having a spring load adjusting device according to a first embodiment of the present disclosure;

FIG. 2 is a schematically enlarged cross-sectional view showing the spring load adjusting device of FIG. 1;

FIG. 3 is a schematic front view showing the spring load adjusting device, when viewed it in a direction of an arrow A in FIG. 2;

FIG. 4 is a schematic development view showing a swaged-part forming portion;

FIG. 5 is a process chart showing steps for a method of adjusting a spring load of the spring load adjusting device;

FIG. 6 is a schematic cross-sectional view showing a process for forming swaged portions;

FIG. 7 is a schematic front view of an axial end of a sleeve member showing a condition that the swaged portion is formed in each of first stepped portions;

FIG. 8 is a schematic front view of the axial end of the sleeve member showing a condition that the swaged portion is formed in each of second stepped portions;

FIG. 9 is a schematic front view of the axial end of the sleeve member showing a condition that the swaged portion is formed in each of third stepped portions;

FIG. 10 is a schematic cross-sectional view of the spring load adjusting device taken along a line X-X in FIG. 7;

FIG. 11 is a schematic perspective view showing an adjust screw member according to a second embodiment of the present disclosure;

FIG. 12 is a schematic side view showing the adjust screw member of FIG. 11;

FIG. 13 is a schematic front view of the adjust screw member of the second embodiment for explaining a relationship between each of swaged portions and each of a first inclined portion “α” and a second inclined portion “β”;

FIG. 14 is a schematic development view showing the relationship between the swaged portions and each of the first inclined portion “α” and the second inclined portion “β” of the second embodiment;

FIG. 15 is a schematically enlarged cross-sectional view showing a spring load adjusting device according to a third embodiment of the present disclosure;

FIG. 16 is a schematic front view showing the spring load adjusting device of the third embodiment before swaged portions are formed, when viewed it in a direction of an arrow B in FIG. 15;

FIG. 17 is a schematic development view showing a press-force receiving portion of an adjust screw member according to the third embodiment;

FIG. 18 is a schematic front view of an axial end of a sleeve member of the third embodiment showing a condition that the swaged portion is formed in each of first stepped portions;

FIG. 19 is a schematic front view of the axial end of the sleeve member of the third embodiment showing a condition that the swaged portion is formed in each of second stepped portions;

FIG. 20 is a schematic front view of the axial end of the sleeve member of the third embodiment showing a condition that the swaged portion is formed in each of third stepped portions;

FIG. 21 is a schematic front view showing a spring load adjusting device according to a fourth embodiment of the present disclosure; and

FIG. 22 is a schematic development view showing a press-force receiving portion of the fourth embodiment.

### DETAILED DESCRIPTION OF THE EMBODIMENTS

The present disclosure will be explained hereinafter by way of multiple embodiments and/or modifications with reference to the drawings. The same reference numerals are given to the same or similar structures and/or portions in order to avoid repeated explanation.

### First Embodiment

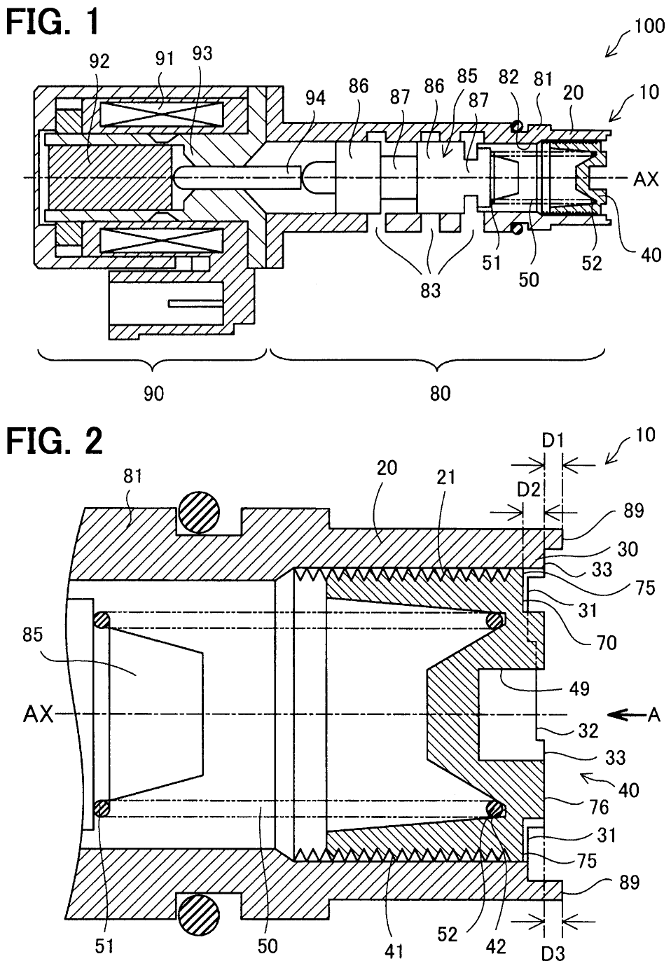

As shown in FIG. 1, a spring load adjusting device 10 of a first embodiment is applied to a spool valve unit 80 of a linear solenoid valve 100 and adjusts a spring load for the spool valve unit 80. The linear solenoid valve 100 is used for controlling oil pressure of working oil to be supplied to, for example, an automatic transmission apparatus (not shown) for an automotive vehicle. More exactly, the linear solenoid valve 100 is provided in a hydraulic circuit (not shown) for the automatic transmission apparatus. The linear solenoid valve 100 includes the spool valve unit 80 and an electromagnetic unit 90, which is coaxially arranged with the spool valve unit 80 in an axial direction (an axis line AX) of the linear solenoid valve 100.

The spool valve unit 80 controls an opened or closed condition of each oil ports 83 (explained below) and adjusts an opening degree thereof. The spool valve unit 80 includes a sleeve member 81, a spool member 85, a spring member 50 and the spring load adjusting device 10.

The sleeve member 81 is formed in a cylindrical shape. The sleeve member 81 includes a spool accommodation hole 82 extending along the axis line AX and multiple oil ports 83, each of which is extending in a radial direction (perpendicular to the axis line AX) of the sleeve member 81 and communicated to an inside of the spool accommodation hole 82. The spool member 85 is movably inserted into the spool accommodation hole 82, so that the spool member 85 is movable therein in the axial direction. The spool member 85 is formed in a rod shape, in which large-diameter portions 86 and small-diameter portions 87 are alternately formed in the direction of the axis line AX. When the spool member 85 is moved in the axial direction, each of the oil ports 83 is operatively opened or closed and the opening degree of the opened oil port 83 is controlled depending on axial positions of the respective large-diameter portions 86 and the small-diameter portions 87 in the direction of the axis line AX. The multiple oil ports 83 are arranged along the axial direction. The multiple oil ports 83 include an inlet port connected to an oil pump (not shown) so that the working oil is supplied to the inlet port, an outlet port connected to a clutch device (not shown) of the automatic transmission apparatus so that the working oil is supplied thereto, and a drain port for discharging the working oil to an outside of the spool valve unit 80. One of axial ends of the sleeve member 81, that is, an axial end of a right-hand side in the drawing opposite to the other axial end of a left-hand side connected to the electromagnetic unit 90, works as a female screw member 20 of the spring load adjusting service 10 (explained below). The spring member 50 is composed of a compression coil spring. One of coil ends of the spring member 50 (a coil end 51 of the left-hand side) is in contact with an axial end of the spool member 85 (an axial end of the right-hand side) and is supported by the axial end of the spool member 85. The spring member 50 biases the spool member 85 in the axial direction to the electromagnetic unit 90 (in a leftward direction; hereinafter, a first axial direction). The spring load adjusting device 10 is provided at the axial end of the spool valve unit 80 (the axial end of the right-hand side) opposite to the axial end of the left-hand side connected to the electromagnetic unit 90.

The electromagnetic unit 90 drives the spool valve unit 80. The electromagnetic unit 90 is connected to an electronic control unit (not shown; hereinafter, the ECU) and controlled by the ECU. When electric power is supplied to the electromagnetic unit 90, an electromagnetic coil 91 is excited to generate an electromagnetic field and a plunger 92 is attracted by the electromagnetic field in the axial direction to an attracting core 93 (in a rightward direction; hereinafter, a second axial direction). Then, a pushing force is applied from the plunger 92 to the spool member 85 via a shaft member 94. This pushing force is applied to the spool member 85 in the second axial direction opposite to the first axial direction of the biasing force of the spring member 50. As a result, an axial position of the spool member 85 is changed relative to the sleeve member 81 when the electric power is supplied to the electromagnetic unit 90 and thereby the opened or closed condition of each oil port 83 as well as the opening degree of the opened oil port 83 is controlled.

As shown in FIG. 2, the spring load adjusting device 10 includes the female screw member 20, which is a part of the sleeve member 81, and an adjust screw member 40.

The female screw member 20 is formed in a cylindrical shape and a female screw 21 is formed at an inner peripheral surface of the female screw member 20. The female screw member 20 has a swaged-claw forming portion 30 at its axial end (of the right-hand side) opposite to the electromagnetic unit 90. The swaged-claw forming portion 30 outwardly extends in the second axial direction from the inner peripheral surface of the female screw member 20. When the swaged-claw forming portion 30 is plastically deformed in a radial-inward direction, multiple swaged claws 60 (as shown in FIGS. 6 to 10) are formed, so that an axial end surface 70 of the adjust screw member 40 is firmly held in the axial direction (fixed to the female screw member 20). The swaged claw 60 not only fixes an axial position of the adjust screw member 40 but also pushes the adjust screw member 40 in the first axial direction (in the axial direction from the spool member 80 to the electromagnetic unit 90). The swaged-claw forming portion 30 and the swaged claws 60 will be further explained below.

As shown in FIG. 2, the adjust screw member 40 is formed in a cylindrical shape having a closed end at its right-hand end and inserted into an inside of the female screw member 20. The adjust screw member 40 includes a male screw 41, a spring holding portion 42, the axial end surface 70, a tool insertion portion 49 and so on. The male screw 41 is formed at an outer peripheral surface of the adjust screw member 40, so that the male screw 41 is engaged with the female screw 21 formed in the female screw member 20. The spring holding portion 42 is formed at a bottom portion (a right-hand bottom wall) of the adjust screw member 40 and holds one of axial ends (a right-hand end 52) of the spring member 50.

The axial end surface 70 forms an end surface of the adjust screw member 40 on a right-hand axial end opposite to another axial end (a left-hand axial end) facing the electromagnetic unit 90 (shown in FIG. 1). A press-force receiving portion 75 is formed at an outer peripheral portion of the axial end surface 70. The press-force receiving portion 75 is firmly held in the axial direction by the swaged claws 60, as explained below. The tool insertion portion 49 is formed at a center of the axial end surface 70, to which a tool (not shown) is inserted in an assembling process of the adjust screw member 40 to the sleeve member 81. In the present embodiment, the tool insertion portion 49 is formed in a longitudinal groove having a rectangular cross-sectional shape on a plane perpendicular to the axial direction, into which a flat-blade screw driver (hereinafter, an adjusting tool) is inserted. The tool insertion portion 49 may have a groove of a hexagonal geometry, so that a hexagonal wrench can be inserted into the tool insertion portion 49. A screwed amount (a screw insert amount) of the adjust screw member 40 with respect to the female screw member 20 is adjusted by rotating the adjusting tool engaged with tool insertion portion 49.

When the screwed amount of the adjust screw member 40 with respect to the female screw member 20, that is, the screw insert amount of the male screw 41 with respect to the female screw 21, is adjusted, the axial position of the adjust screw member 40 relative to the female screw member 20 is decided. A spring load for the spring member 50 is thereby adjusted to become a target value. The target value for the spring load is set in advance, for example, depending on an oil pressure range of the working oil. A screw gap (not shown), which is suitable for the screw engagement, exists between the female screw 21 and the male screw 41. The adjust screw member 40 can be easily rotated in the inside of the female screw member 20 and the screw insert amount can be smoothly adjusted due to the existence of the screw gap.

The spring load adjusting device 10 of the present embodiment is applied to the spool valve unit 80 of the linear solenoid valve 100, which is provided in the hydraulic circuit for supplying the working oil to the automatic transmission apparatus of the automotive vehicle. A high sealing property is required for the linear solenoid valve 100, in particular, between the sleeve member 81 and the adjust screw member 40, when the high oil pressure is applied to the linear solenoid valve 100 or when a space for the spring member 50 is used as an oil chamber, such as, a damping chamber, a feedback chamber, a pilot pressure chamber and so on. In the spring load adjusting device 10 of the present embodiment, the swaged-claw forming portion 30 of the female screw member 20 is plastically deformed after the spring load for the spring member 50 is adjusted. The multiple swaged claws 60 are thereby formed and the adjust screw member 40 is pressed by the swaged claws 60 in the first axial direction (in the axial direction from the spool member 80 to the electromagnetic unit 90), in order to assure the high sealing property. When the adjust screw member 40 is pressed in the first axial direction, a screw thread of the female screw 21 formed in the female screw member 20 and a screw thread of the male screw 41 formed in the adjust screw member 40 are pushed in the first axial direction. The screw thread of the female screw 21 and the screw thread of the male screw 41 are continuously brought into contact with each other along a spiral thread groove formed between the female screw 21 and the male screw 41. Accordingly, the high sealing property can be obtained between the sleeve member 81 and the adjust screw member 40.

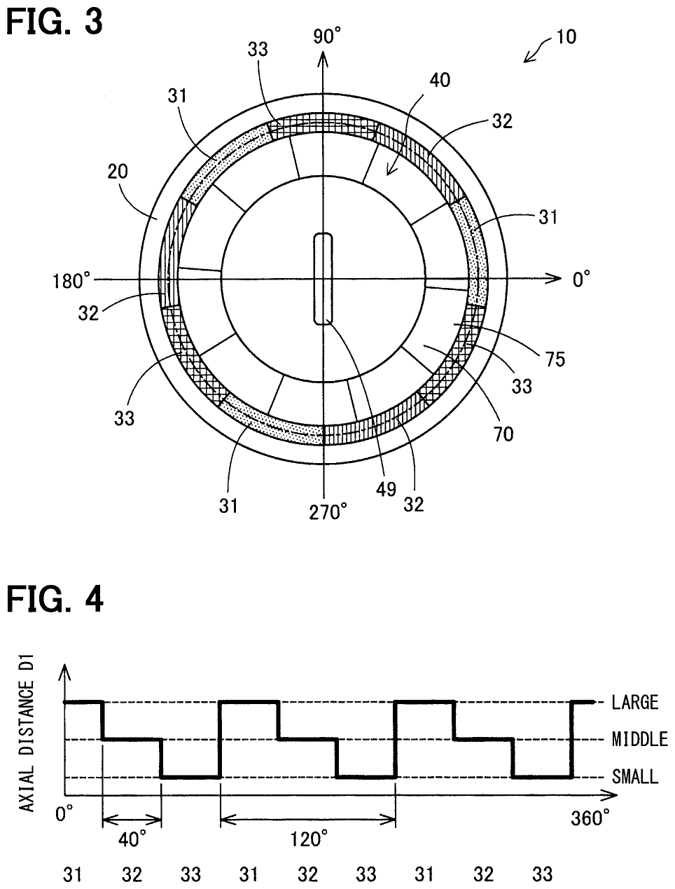

A structure of the swaged-claw forming portion 30 will be explained with reference to FIGS. 2 to 4. FIG. 4 shows a development of the swaged-claw forming portion 30, when it is developed along a one-dot-chain line in FIG. 3. In FIGS. 3 and 4, for the purpose of simple explanation, each circumferential position of the spring load adjusting device 10 with respect to the axis line AX is indicated by an angle.

As shown in FIG. 3, the swaged-claw forming portion 30 of the female member 20 includes multiple first stepped portions 31, multiple second stepped portions 32 and multiple third stepped portions 33, which are alternately arranged in this order in a circumferential direction of the female screw member 20. In the present embodiment, three step groups are formed in the circumferential direction in such a way that each of the step groups includes the first to the third stepped portions 31 to 33. As shown in FIGS. 3 and 4, in each of the step groups, the first to the third stepped portions 31 to 33 are arranged in this order at a circumferential interval of 40 degrees. The three step groups are arranged at the circumferential interval of 120 degrees.

As shown in FIGS. 2 and 4, a height of the respective stepped portion 31, 32 or 33 (a length in the axial direction) is different from one another. An axial distance between the first stepped portion 31 and a front end 89 (a right-most end in FIG. 2) of the sleeve member 81 is made to be the largest distance among axial distances between each of the stepped portions 31 to 33 and the front end 89. The axial distance between each of the stepped portions 31, 32 and 33 and the front end 89 of the sleeve member 81 is also referred to as a swage start distance “D1” or a first axial distance “D1”. “D1” shown in FIG. 2 is the first axial distance between the third step portion 33 and the front end 89 of the sleeve member 81.

The axial distance between the second stepped portion 32 and the front end 89 (the first axial distance “D1(32)” for the second step portion 32) is made to be smaller than the axial distance between the first stepped portion 31 and the front end 89 (the first axial distance “D1(31)” for the first step portion 31). The axial distance between the third stepped portion 33 and the front end 89 (the first axial distance “D1(33)” for the third step portion 33) is made to be smaller than the axial distance between the second stepped portion 32 and the front end 89 (the first axial distance “D1(32)” for the second stepped portion 32). Therefore, respective axial distances between each of the stepped portions 31 to 33 and the press-force receiving portion 75 formed at the axial end surface 70 of the adjust screw member 40 are correspondingly different from one another. Each of the axial distances between each of the stepped portions 31, 32 and 33 and the axial end surface 70 is also referred to as a second axial distance “D2”. For example, “D2” shown in FIG. 2 is the second axial distance between the third stepped portion 33 and the axial end surface 70 (the press-force receiving portion 75).

### (Process for Adjusting Spring Load)

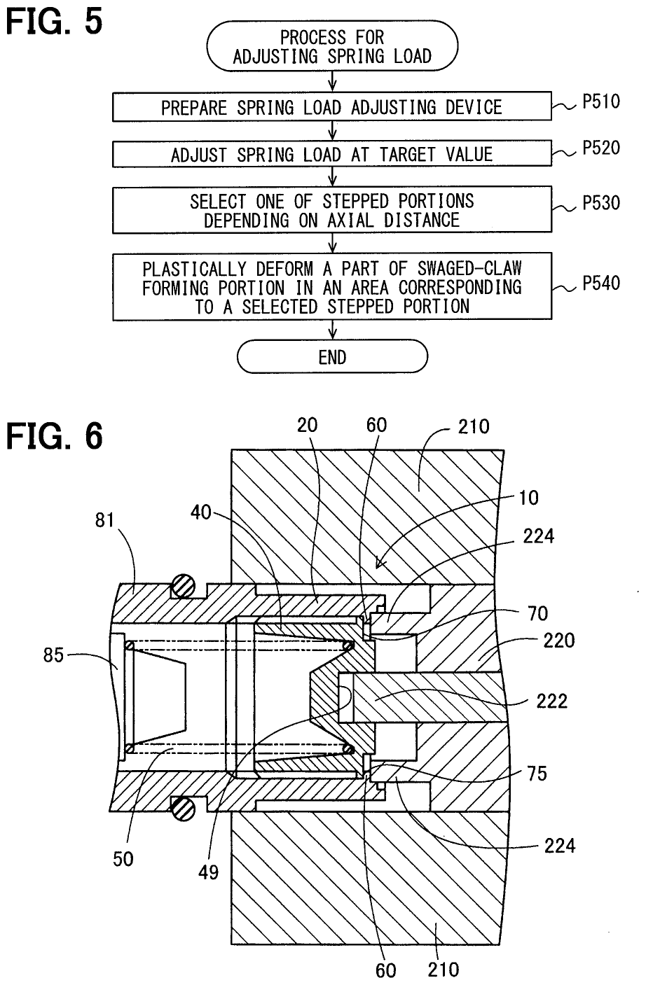

A process for adjusting the spring load will be explained with reference to FIG. 5. At first, the spring load adjusting device 10 having the above explained structure is prepared at a step P510. The screwed amount between the female screw 21 and the male screw 41 is adjusted in order to adjust the relative position of the adjust screw member 40 to the female screw member 20 in the axial direction. The spring load for the spring member 50 is thereby controlled at the target value at a step P520. After the step P520, one of the multiple stepped portions (one of the first to the third stepped portions 31 to 33) of each step group is selected at a step P530 depending on the second axial distance “D2” between the swaged-claw forming portion 30 (each of the stepped portions 31 to 33) and the press-force receiving portion 75 formed at the axial end surface 70 of the adjust screw member 40. When one of the multiple stepped portions is selected for one of the step groups, the corresponding stepped portions belonging to the other two step groups are likewise selected. For example, when the first stepped portion 31 is selected, the first stepped portion 31 in each of the three step groups is selected.

At the step P530, one of the stepped portions 31, 32 or 33 is selected in such a way that the second axial distance “D2” between the swaged-claw forming portion 30 and the press-force receiving portion 75 is within a predetermined distance range. At a step P540, the swaged claws 60 each having a proper amount of the plastic deformation are formed at the selected stepped portions. More exactly, one of the stepped portions 31, 32 or 33 is selected at the step P530 in the following manner.

As shown in FIG. 2, one of predetermined portions of the axial end surface 70 of the adjust screw member 40 (for example, a front-end surface) is selected in advance as a reference portion 76. When an axial distance between the reference portion 76 and the front end 89 of the sleeve member 81 (hereinafter, an adjust-screw distance or a third axial distance “D3”) is larger than the predetermined distance range, the first stepped portion 31 having the largest first axial distance “D1(31)” is selected. On the other hand, when the adjust-screw distance (the third axial distance “D3”) is within the predetermined distance range, the second stepped portion 32 having the first axial distance “D1(32)” of an intermediate value is selected. Furthermore, when the adjust-screw distance (the third axial distance “D3”) is smaller than the predetermined distance range, the third stepped portion 33 having the smallest first axial distance “D1(33)” is selected. As above, the stepped portion having the larger first axial distance “D1” is selected, as the adjust-screw distance (the third axial distance “D3”) becomes larger. In other words, the stepped portion having the smaller first axial distance “D1” is selected, as the adjust-screw distance (the third axial distance “D3”) becomes smaller. As a result, it is possible to easily select one of the stepped portions 31 to 33 depending on the second axial distance “D2” by use of the adjust-screw distance (the third axial distance “D3”).

As shown in FIG. 5, at the step P540, the one of the stepped portions 31 to 33 in each step group, which is selected at the step P530, is plastically deformed to form the swaged claw 60, which is deformed to the press-force receiving portion 75 at the axial end surface 70 of the adjust screw member 40. When the swaged claws 60 are formed at the step P540, the adjust screw member 40 is pressed in the first axial direction (in the axial direction to the spring member 50). When the step P540 is completed, the spring load for the spring member 50 is adjusted and the high sealing property is obtained in the spool valve unit 80.

As shown in FIG. 6, the swaged claws 60 are formed by a swaging tool 210 and a swaging press portion 220. The swaging tool 210 has a cylindrical shape. The swaging press portion 220 also has a cylindrical shape, which is movably inserted into the swaging tool 210. The swaging press portion 220 is operated by oil pressure. The swaging press portion 220 includes a rotation limiting portion 222 and multiple pushing portions 224 (three pushing portions 224 equally arranged in the circumferential direction in the present embodiment).

The rotation limiting portion 222 is inserted into the tool insertion portion 49 of the adjust screw member 40 to prevent the adjust screw member 40 from rotating during the process of forming the swaged claws 60. The pushing portions 224 are arranged in the circumferential direction of the swaging press portion 220 at equal intervals and projected in the first axial direction in such a way that each of the pushing portions 224 is axially opposed to respective stepped portions, at which the swaged claws 60 are formed. In the present embodiment, each of the pushing portions 224 of an arc shape is so formed that a center angle thereof is made to be slightly smaller than that of each of the stepped portions 31, 32 and 33 of the swaged-claw forming portion 30, that is, smaller than 40 degrees. In other words, a circumferential length of the pushing portion 224 is made to be smaller than that of each of the stepped portions 31, 32 and 33. Alternatively, the center angle of each pushing portion 224 may be made to be equal to that of each stepped portion 31, 32 or 33. Each of the pushing portions 224 pushes the selected stepped portion 31, 32 or 33 of the swaged-claw forming portion 30 in the first axial direction in order that the selected stepped portion 31, 32 or 33 is plastically deformed in the radial-inward direction. As a result, three swaged claws 60 are formed in the female screw member 20 (that is, the right-hand axial end of the sleeve member 81) at such positions corresponding to the selected stepped portion 31, 32 or 33 in each step group. The three swaged claws 60 are arranged in the circumferential direction at the interval of 120 degrees.

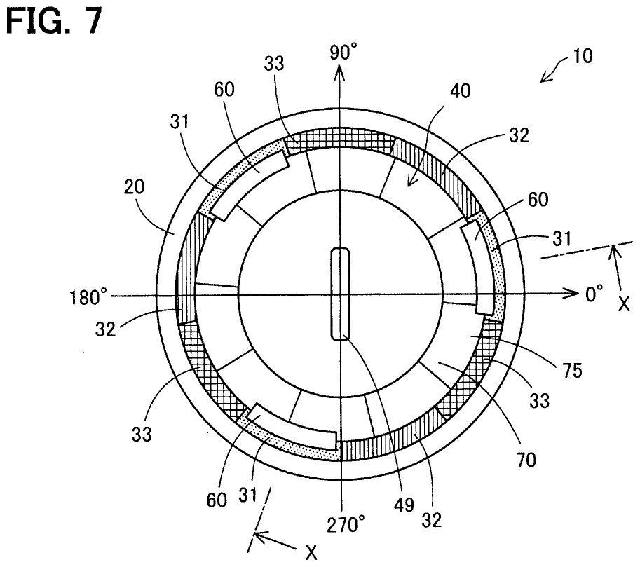

As shown in FIG. 7, three swaged claws 60 are formed at such positions corresponding to the positions of the first stepped portions 31, when the first stepped portion 31 is selected at the step P530 of FIG. 5. The swaged claws 60 are respectively swaged to the press-force receiving portion 75 of the axial end surface 70 of the adjust screw member 40 at three positions arranged in the circumferential direction at equal intervals, so that the adjust screw member 40 is pushed in the first axial direction.

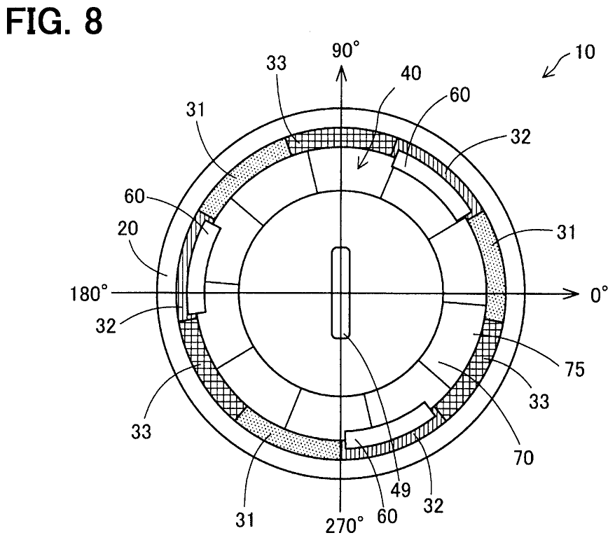

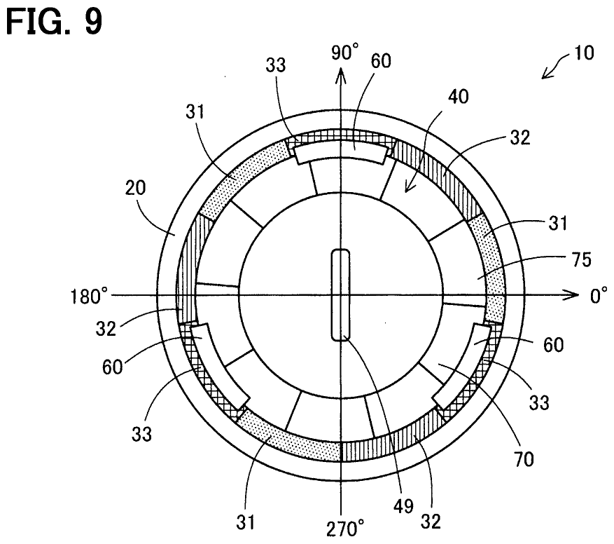

As shown in FIG. 8, in a similar manner to FIG. 7, three swaged claws 60 are formed at such positions corresponding to the positions of the second stepped portions 32, when the second stepped portion 32 is selected at the step P530 of FIG. 5. In addition, as shown in FIG. 9, three swaged claws 60 are likewise formed at such positions corresponding to the positions of the third stepped portions 33, when the third stepped portion 33 is selected at the step P530 of FIG. 5.

In FIG. 10, the first stepped portions 31 before forming the swaged claws 60 (that is, before the plastic deformation of the swaged-claw forming portion 30) are indicated by dotted lines. As shown in FIG. 10, the corresponding portions of the first stepped portions 31 are plastically deformed in the radial-inward direction and thereby swaged in the axial direction to the press-force receiving portion 75 of the axial end surface 70 of the adjust screw member 40.

In the present embodiment, as shown in the step P530 of FIG. 5, one of the stepped portions 31, 32 and 33 is selected in order that the second axial distance “D2” between the swaged-claw forming portion 30 (the selected stepped portion) and the press-force receiving portion 75 is within the predetermined distance range. It is, thereby, possible to form the swaged claw 60 having the appropriate amount of the plastic deformation, at the step P540 of FIG. 5.

According to the present embodiment, it is possible to avoid a situation that the second axial distance “D2” between the swaged-claw forming portion 30 and the press-force receiving portion 75 becomes too small after adjusting the spring load for the spring member 50 and that the amount of the plastic deformation of the swaged-claw forming portion 30 may become extremely small. In other words, it is possible to avoid a situation that a thickness of the swaged claw 60 in the axial direction may become extremely small. Accordingly, it is possible to avoid a situation that the sealing property between the adjust screw member 40 and the sleeve member 81 may be decreased.

In addition, it is possible to avoid a situation that the second axial distance “D2” between the swaged-claw forming portion 30 and the press-force receiving portion 75 becomes too large after adjusting the spring load for the spring member 50 and that the amount of the plastic deformation of the swaged-claw forming portion 30 may become extremely large. As a result, it is possible to avoid a situation that deformation and/or stress may be unintentionally generated in a portion adjacent to the swaged-claw forming portion 30, when the swaged claws 60 are formed.

According to the spring load adjusting device 10 of the first embodiment, the multiple stepped portions 31, 32 and 33 are formed in the swaged-claw forming portion 30 along its circumferential direction, wherein the second axial distances “D2” for the multiple stepped portions 31, 32 and 33 are different from one another. The second axial distance “D2” is the distance between the swaged-claw forming portion 30 (the selected stepped portion) of the female screw member 20 and the press-force receiving portion 75 formed on the axial end surface 70 of the adjust screw member 40. In the above structure, one of the stepped portions 31 to 33 can be selected depending on the axial position of the adjust screw member 40 relative to the female screw member 20 after the adjustment of the spring load and such a selected stepped portion of the swaged-claw forming portion 30 is plastically deformed to form the swaged claw 60. Therefore, it is possible to form the swaged claw 60 having the appropriate amount of the plastic deformation independently from the axial position of the adjust screw member 40 relative to the female screw member 20 after the adjustment of the spring load. In other words, not only the high sealing property can be obtained between the female screw member 20 (a part of the sleeve member 81) and the adjust screw member 40 but also the spring load can be properly adjusted in the wide spring load range.

In addition, since the multiple stepped portions 31 to 33 are formed in the swaged-claw forming portion 30 of the female screw member 20, it is possible to avoid a situation that a structure of the adjust screw member 40 may become complicated. Furthermore, since there are three stepped portions 31 to 33, each having the different height (the axial distance) from one another, it is possible to adjust the spring load in the wider spring load range, when compared with a case in which only two stepped portions having different heights are provided. Furthermore, since three stepped portions are provided in the circumferential direction in each step group of the stepped portions 31 to 33, it is possible to avoid a situation that the pushing force may be un-equally applied in the circumferential direction from each swaged claw 60 to the adjust screw member 40. Namely, it is possible to avoid a situation that the sealing property may be decreased between the sleeve member 81 and the adjust screw member 40.

In addition, since the swaged claws 60 push the adjust screw member 40 in the first axial direction, the screw thread of the female screw 21 and the screw thread of the male screw 41 are continuously brought into contact with each other along the spiral groove between them and thereby the high sealing property is assured between the sleeve member 81 and the adjust screw member 40. Since high accuracy of dimension is not required for the screw gap between the female screw 21 and the male screw 41, it is possible to avoid a situation that a manufacturing cost of the related parts may be increased for assuring the high sealing property. In addition, it is possible to avoid a situation that an axial length of the female screw 21 as well as an axial length of the female screw 41 may become longer for assuring the high sealing property. It is, therefore, possible to avoid a situation that an axial length of the spool valve unit 80 as well as an axial length of the linear solenoid valve 100 may become longer.

### Second Embodiment

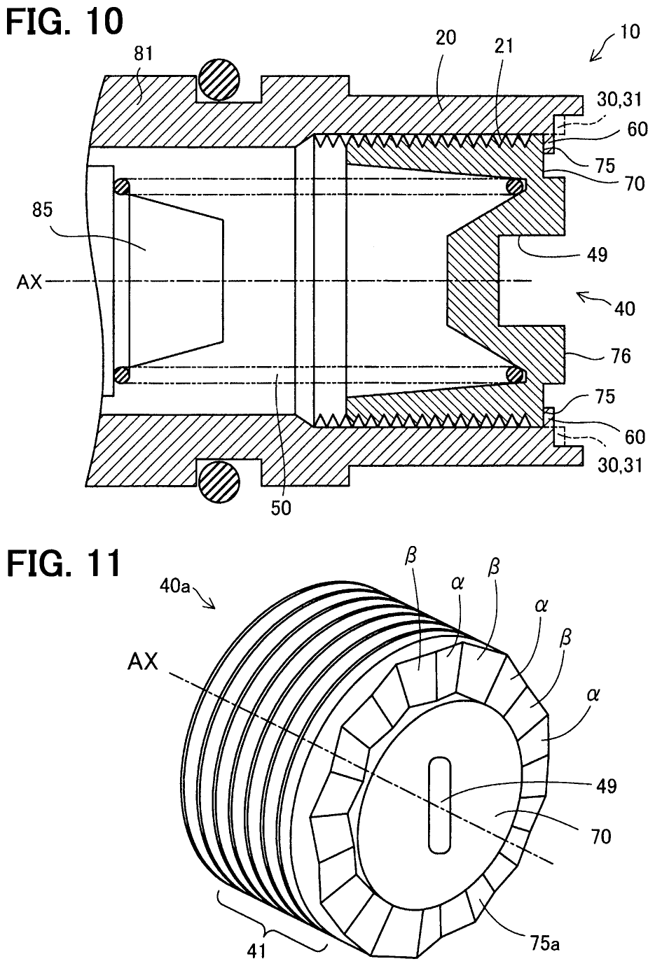

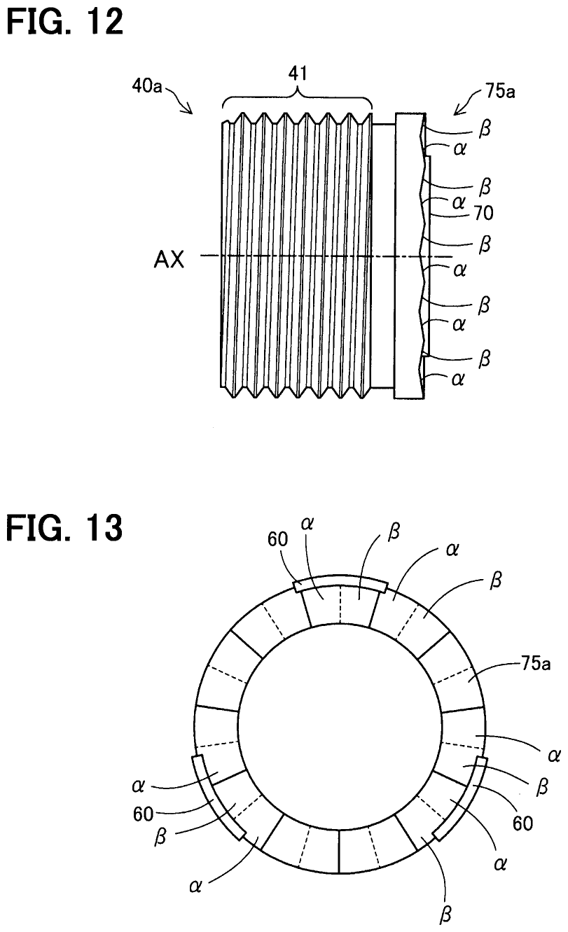

As shown in FIGS. 11 and 12 showing an adjust screw member 40a of a second embodiment of the present disclosure, a structure of a press-force receiving portion 75a formed at the axial end surface 70 of the adjust screw member 40a is different from that of the adjust screw member 40 of the first embodiment.

In the press-force receiving portion 75a of the adjust screw member 40a, multiple first inclined portions “α” and multiple second inclined portions “β” are formed in such a way that the first inclined portions “α” and the second inclined portions “β” are alternately arranged in the circumferential direction. Each of the first inclined portions “α” is inclined in a direction different from each of the second inclined portions “β” on a plane perpendicular to the axis line AX. When the first inclined portions “α” are pushed in the first axial direction, a rotational force is generated in the adjust screw member 40a in either one of a screw fastening direction and a screw unfastening direction. On the other hand, when the second inclined portions “β” are pushed in the first axial direction, the rotational force is generated in the adjust screw member 40a in the other one of the screw fastening direction and the screw unfastening direction. In the present embodiment, an absolute value of an inclined angle of the first inclined portion “α” and an absolute value of an inclined angle of the second inclined portion “β” are equal to each other. However, the absolute value for the inclined angle of the first inclined portion “α” may be set at a value different from that for the inclined angle of the second inclined portion “β”. In addition, each of the absolute value for the inclined angle of the first inclined portion “α” and the absolute value for the inclined angle of the second inclined portion “β” may be equal to an absolute value of a screwed angle of the male screw 41 formed in the adjust screw member 40a. However, the absolute value for the first inclined portion “α” and the absolute value for the second inclined portion “β” may be different from the absolute value for the screwed angle of the male screw 41. In the present disclosure, each of the inclined angle and the screwed angle is an angle with respect to the plane perpendicular to the axis line AX. In FIG. 12, the absolute value of the inclined angle for the first inclined portion “α” and the absolute value of the inclined angle for the second inclined portion “β” are indicated as being larger than the absolute value of the screwed angle, only for the purpose of illustration.

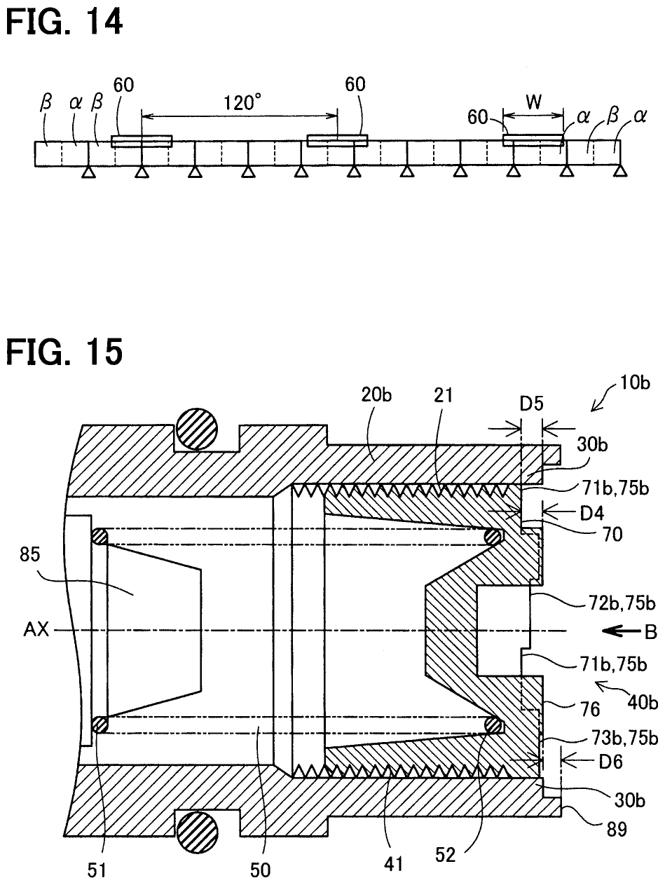

A positional relationship among the first inclined portions “α”, the second inclined portions “β” and the swaged claws 60 will be explained with reference to FIGS. 13 and 14. FIG. 13 shows the press-force receiving portion 75a and the swaged claws 60 after the swaged-claw forming portion 30 is plastically deformed, when viewed them in the axial direction. FIG. 14 shows a development of the first and the second inclined portions “α” and “β” in the circumferential direction of FIG. 13. In the same manner to the first embodiment, three swaged claws 60 are formed in the second embodiment, wherein the swaged claws 60 are arranged in the circumferential direction at equal intervals.

In the adjust screw member 40a of the present embodiment, each of the swaged claws 60 is formed in such an area, in which at least one top portion is located at a boundary between the neighboring first and second inclined portions “α” and “β”. Each position of the top portions is indicated by a triangle in FIG. 14.

In a similar manner to the first embodiment, a center angle of the swaged claw 60 corresponding to a circumferential width “W” is almost equal to that of each pushing portion 224 of the swaging press portion 220 shown in FIG. 6. In the present embodiment, the press-force receiving portion 75a is divided into 22 portions in the circumferential direction, so that the first inclined portions “α” are formed in 11 divided portions while the second inclined portions “β” are formed in the remaining 11 divided portions between the neighboring first inclined portions “α”.

According to the above structure, the adjust screw member 40a is pushed by the swaged claws 60 in the first axial direction at three circumferential areas, each of which includes the top portion formed at the boundary between the neighboring first and second inclined portions “α” and “β”. The rotational force is generated in the adjust screw member 40a in one of the screw fastening direction and the screw unfastening direction by the press force applied to the first inclined portion “α”. On the other hand, the rotational force is generated in the adjust screw member 40a in the opposite direction (that is, in the other one of the screw fastening direction and the screw unfastening direction) by the press force applied to the second inclined portion “β”. The rotation of the adjust screw member 40a is limited in both directions including the screw fastening direction and the screw unfastening direction. As a result, it is possible to avoid a situation that the relative position of the adjust screw member 40a to the sleeve member 81 in the axial direction is changed by a vibration of the linear solenoid valve 100 and/or an impact to the linear solenoid valve 100. It is, therefore, possible to avoid a situation that the spring load may be changed after it is adjusted.

Each of the swaged claws 60 is formed in each of the three circumferential areas, each of which includes the top portion formed at the boundary between the neighboring first and second inclined portions “α” and “β”. It is, thereby, possible to avoid a situation that the press force may be unevenly applied to the adjust screw member 40a in the circumferential direction, when the press force is applied from the three swaged claws 60 to the adjust screw member 40a in the axial direction. As a result, it is possible to avoid a situation that the sealing property may be decreased between the sleeve member 81 and the adjust screw member 40a.

As above, according to the spring load adjusting device 10 of the second embodiment having the adjust screw member 40a, the same advantages to those of the first embodiment can be obtained. In addition, the press-force receiving portion 75a has the first inclined portions “α” for applying the rotational force to the adjust screw member 40a in the screw fastening or unfastening direction upon receiving the press force in the first axial direction. The press-force receiving portion 75a further has the second inclined portions “β” for applying the rotational force to the adjust screw member 40a in the opposite direction upon receiving the press force in the first axial direction. As a result, it is possible to restrict by the swaged claws 60 the relative rotation of the adjust screw member 40a to the sleeve member 81 in both directions, including the screw fastening direction and the screw unfastening direction. Accordingly, it is possible to avoid the situation that the relative position of the adjust screw member 40a to the sleeve member 81 in the axial direction is changed by the vibration of the linear solenoid valve 100 and/or the impact from the outside to the linear solenoid valve 100. It is, therefore, possible to avoid the situation that the spring load may be changed after it is once adjusted.

In the present embodiment, the absolute value of the inclined angle for the first inclined portions “α”, the absolute value of the inclined angle for the second inclined portion “β” and the absolute value of the screwed angle for the male screw 41 are made to be equal to one another. Therefore, the press force of the swaged claws 60 can be effectively applied to the adjust screw member 40a as a pushing force for pushing the screw thread of the male screw 41 to the screw thread of the female screw 21. As a result, a frictional force of the adjust screw member 40a with respect to the female screw member 20 can be made larger, to thereby avoid a situation that the adjust screw member 40a is moved from its adjusted position.

### Third Embodiment

As shown in FIGS. 15 and 16, a spring load adjusting device 10b of a third embodiment is different from the spring load adjusting device 10 of the first embodiment in that a female screw member 20b is provided instead of the female screw member 20 and an adjust screw member 40b is provided instead of the adjust screw member 40. More exactly, the third embodiment is different from the first embodiment in that stepped portions are formed not in the female screw member 20b but in the adjust screw member 40b.

The female screw member 20b has a swaged-claw forming portion 30b, in which no stepped portion is formed. A press-force receiving portion 75b is formed at the axial end surface 70 of the adjust screw member 40b. Multiple first stepped portions 71b, multiple second stepped portions 72b and multiple third stepped portions 73b are formed in the press-force receiving portion 75b along its outer peripheral portion, wherein the first to the third stepped portions 71b to 73b are alternately arranged in the circumferential direction of the adjust screw member 40b.

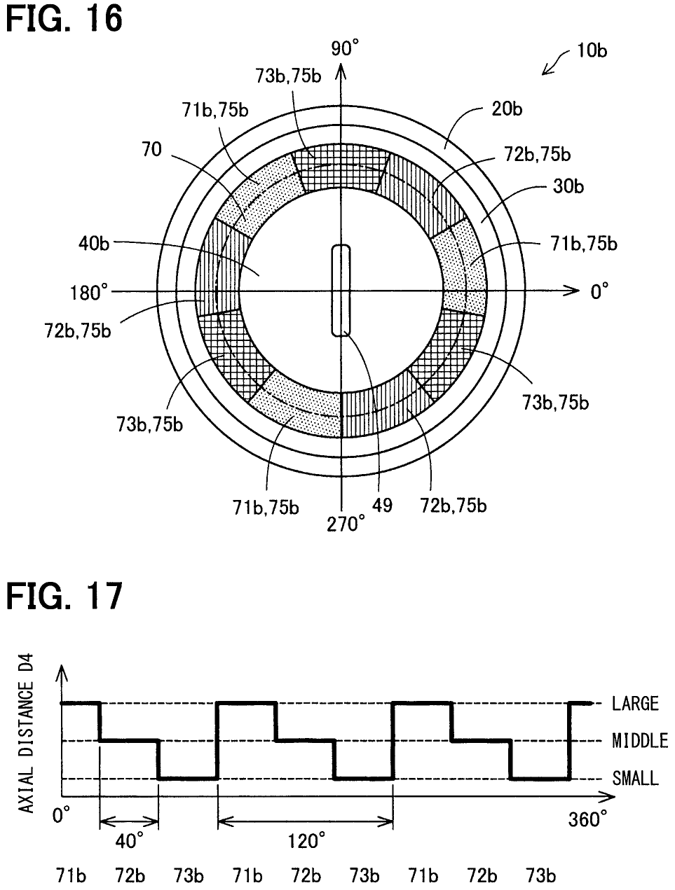

FIG. 17 schematically shows the press-force receiving portion 75b developed along a one-dot-chain line in FIG. 16. In FIGS. 16 and 17, each circumferential position of the press-force receiving portion 75b with respect to the axis line AX of the spring load adjusting device 10b is indicated by a corresponding angle for the purpose of illustration. In each of three step groups, the first to the third stepped portions 71b, 72b and 73b are respectively formed in the circumferential direction. Each of the stepped portions 71b to 73b belonging to the same step group has a height (a length in the axial direction), which is different from one another. Each stepped portion 71b, 72b or 73b belonging to one of the step groups has the height, which is the same to that of the corresponding stepped portion belonging to the other step groups. As shown in FIG. 17, the stepped portions 71b, 72b and 73b are arranged in the circumferential direction at intervals of 40 degrees in each step group, while the same stepped portions 71b, 72b or 73b belonging to the different step groups are respectively formed in the circumferential direction at intervals of 120 degrees.

As shown in FIG. 15, each of the stepped portions 71b, 72b and 73b is formed at the axial end surface 70 (more exactly, at the press-force receiving portion 75b) of the adjust screw member 40b. Each of the stepped portions 71b, 72b and 73b is separated by a fourth axial distance “D4” in the axial direction from the reference portion 76. The reference portion 76 is decided in advance at any optional portion of the axial end surface 70 of the adjust screw member 40b. The fourth axial distance “D4” is also referred to as a distance for the press-force receiving portion 75b. The fourth axial distance “D4(71b)” for the first stepped portion 71b is made to be the largest. The fourth axial distance “D4(72b)” for the second stepped portion 72b is made to be smaller than that “D4(71b)” for the first stepped portion 71b. The fourth axial distance “D4(73b)” for the third stepped portion 73b is made to be smaller than that “D4(72b)” for the second stepped portion 72b. As a result, an axial distance (a fifth axial distance “D5”) between an axial end surface of the swaged-claw forming portion 30b and each of the stepped portions 71b, 72b and 73b is correspondingly different from one another.

A process for adjusting the spring load for the third embodiment is carried out in the same manner to that of the first embodiment shown in FIG. 5. In the step P530, one of the stepped portions 71b, 72b and 73b is selected depending on the fifth axial distance “D5” between the swaged-claw forming portion 30b and the press-force receiving portion 75b (that is, the stepped portions 71b to 73b) formed at the axial end surface 70 of the adjust screw member 40b. More exactly, one of the stepped portions 71b, 72b and 73b is selected in the following manner.

As shown in FIG. 15, an axial distance between the reference portion 76 of the adjust screw member 40b and the front end 89 of the sleeve member 81 is indicated as a sixth axial distance “D6”, which is also referred to as a distance for the adjust screw member 40b. When the sixth axial distance “D6” is larger than the predetermined distance range, the third stepped portion 73b having the smallest fourth axial distance “D4(73b)” is selected. When the sixth axial distance “D6” is within the predetermined distance range, the second stepped portion 72b having the middle fourth axial distance “D4(72b)” is selected. And when the sixth axial distance “D6” is smaller than the predetermined distance range, the first stepped portion 71b having the largest fourth axial distance “D4(71b)” is selected. As above, when the sixth axial distance “D6” becomes larger, the stepped portion having the smaller fourth axial distance “D4” is selected. In other words, when the sixth axial distance “D6” becomes smaller, the stepped portion having the larger fourth axial distance “D4” is selected. Accordingly, it is possible to easily select one of the stepped portions 71b, 72b and 73b by use of the sixth axial distance “D6”.

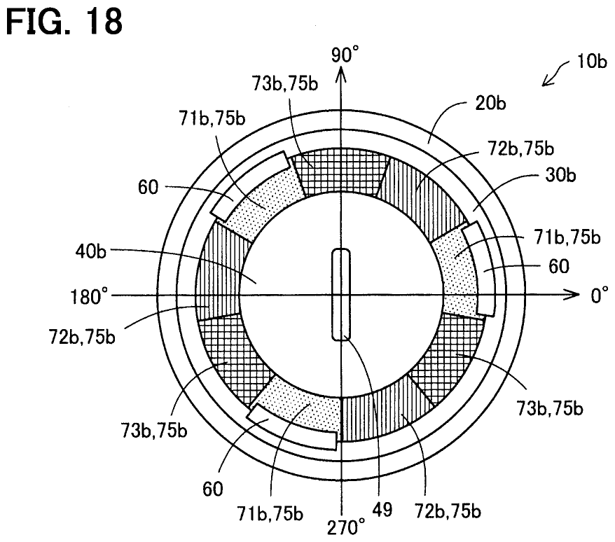

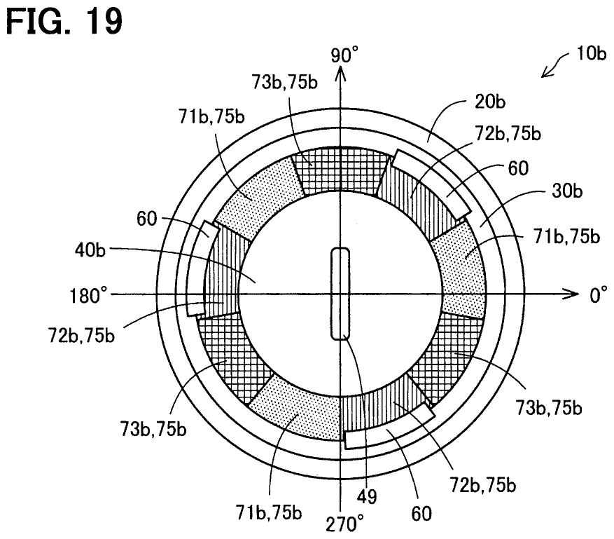

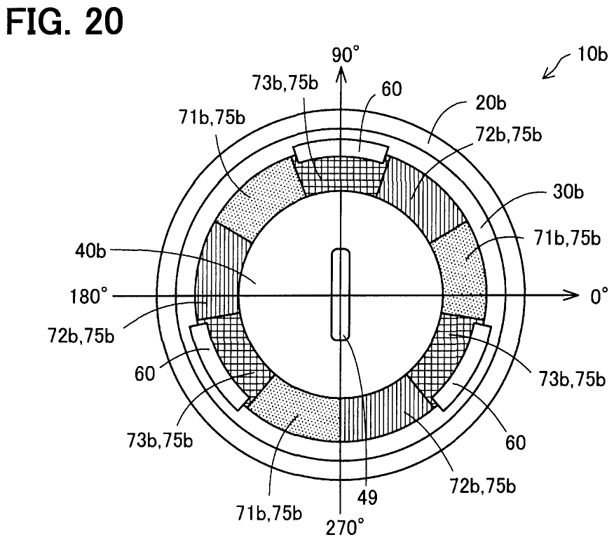

As shown in FIG. 18, in a case that the first stepped portions 71b are selected, three swaged claws 60 are formed in the swaged-claw forming portion 30b at such positions corresponding to the selected first stepped portions 71b. As shown in FIG. 19, in a case that the second stepped portions 72b are selected, three swaged claws 60 are formed in the swaged-claw forming portion 30b at such positions corresponding to the selected second stepped portions 72b. As shown in FIG. 20, in a case that the third stepped portions 73b are selected, three swaged claws 60 are formed in the swaged-claw forming portion 30b at such positions corresponding to the selected third stepped portions 73b. As above, the press-force receiving portion 75b of the adjust screw member 40b is pressed by the swaged claws 60 in the first axial direction at three circumferential positions of the axial end surface 70.

The same advantages to those of the first embodiment can be also obtained in the third embodiment. In addition, since the first to the third stepped portions 71b to 73b are formed at the axial end surface 70 of the adjust screw member 40b, it is possible to avoid a situation that a structure for the swaged-claw forming portion 30b may become complicated.

### Fourth Embodiment

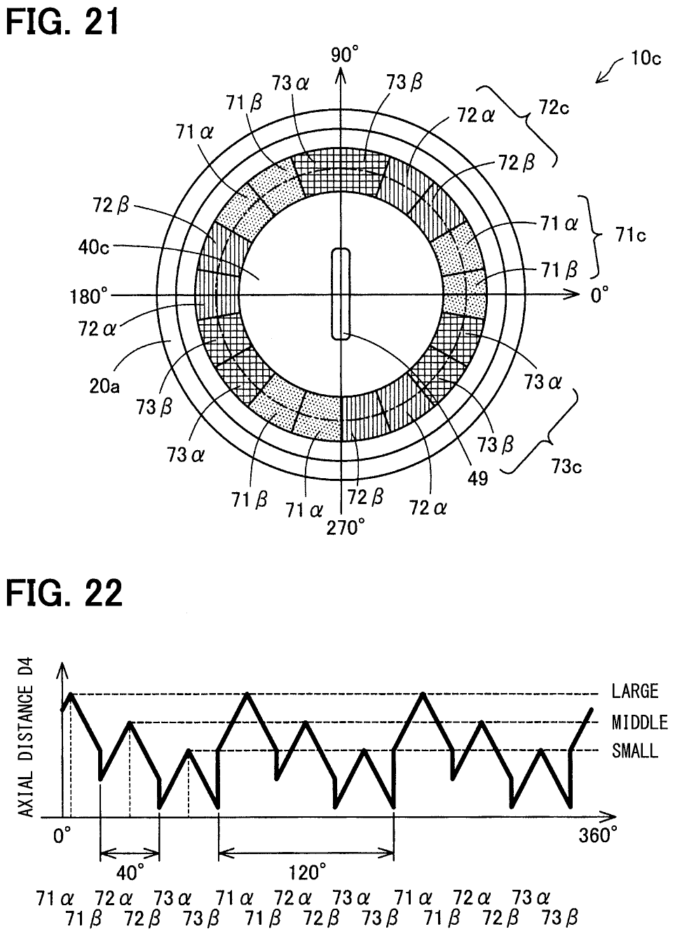

As shown in FIG. 21, a spring load adjusting device 10c of a fourth embodiment is different from the spring load adjusting device 10b of the third embodiment in that an adjust screw member 40c is provided instead of the adjust screw member 40b.

In the adjust screw member 40c of the fourth embodiment, in a similar manner to the third embodiment, three stepped portions 71c, 72c and 73c are alternately formed at a press-force receiving portion of the adjust screw member 40c in the circumferential direction. In each of the step groups for the stepped portions, three stepped portions 71c, 72c and 73c are formed in such a way that each of the stepped portions has the different height from one another (the different length in the axial direction). The height of the stepped portion belonging to one of the step groups is the same to that of the corresponding stepped portion belonging to the other step groups.

In each of the stepped portions 71c, 72c and 73c, each press-force receiving portion is divided into two parts in the circumferential direction. More exactly, each of the first stepped portions 71c is divided into two parts including a first inclined portion “71α” and a second inclined portion “71β”. In a similar manner, each of the second stepped portions 72c is divided into two parts including a first inclined portion “72α” and a second inclined portion “72β”, and each of the third stepped portions 73c is divided into two parts including a first inclined portion “73α” and a second inclined portion “73β”. In a similar manner to the first inclined portion “α” and the second inclined portion “β” of the second embodiment, each of the first inclined portions “71α”, “72α” and “73α” and each of the second inclined portions “71β”, “72β” and “73β” are inclined in the different directions from each other with respect to the plane perpendicular to the axis line AX. As above, the adjust screw member 40c of the fourth embodiment has a structure, in which the structure of the adjust screw member 40a of the second embodiment and the structure of the adjust screw member 40b of the third embodiment are combined to each other.

FIG. 22 schematically shows the press-force receiving portion, which is developed along a one-dot-chain line in FIG. 21. In FIGS. 21 and 22, each circumferential position of the press-force receiving portion with respect to the axis line AX of the spring load adjusting device 10c is indicated by a corresponding angle for the purpose of illustration. The rotational force is generated in the adjust screw member 40c in one of the screw fastening direction and the screw unfastening direction, when the press force is applied to each of the first inclined portions “71α”, “72α” and “73α”. On the other hand, the rotational force is generated in the adjust screw member 40c in the opposite direction (that is, in the other one of the screw fastening direction and the screw unfastening direction), when the press force is applied to each of the second inclined portions “71β”, “72β” and “73β”.

A process for adjusting the spring load for the fourth embodiment is carried out in the same manner to that of the third embodiment. When one of the stepped portions 71c, 72c and 73c is selected and the swaged claws 60 are formed at three positions in the circumferential direction, the adjust screw member 40c is pressed in the first axial direction in each circumferential area, in which the top portion between the first inclined portion “71α, 72α or 73α” and the second inclined portion “71β, 72β or 73β” belonging to the selected same stepped portion 71c, 72c or 73c is located,

The same advantages to those of the second embodiment and the third embodiment can be also obtained in the fourth embodiment.

### Further Embodiments and/or Modifications

(M1) In the first and the second embodiments, the multiple stepped portions 31, 32 and 33 are formed in the swaged-claw forming portion 30 of the sleeve member 81, while the multiple stepped portions 71b, 72b, 73b or 71c, 72c, 73c are formed in the adjust screw member 40b or 40c in the third and the fourth embodiments. However, the present disclosure is not limited to the above embodiments. For example, multiple stepped portions may be formed in both of the swaged-claw forming portion 30 or 30b of the sleeve member 81 and the adjust screw member 40, 40a, 40b or 40c. It is generally sufficient that multiple stepped portions may be provided in either one of the swaged-claw forming portion and the axial end surface of the adjust screw member in the circumferential direction, so that the axial distance between the swaged-claw forming portion and the axial end surface of the adjust screw member is different from a position to a position in the circumferential direction. Even in such a structure, the same advantages to those of the above embodiments can be obtained.

(M2) In the above embodiments, three stepped portions 31, 32, 33 (71b, 72b, 73b or 71c, 72c, 73c) are formed, wherein the height (the axial length) of one of the three stepped portions is different from those of the other two stepped portions in each of the step groups. The stepped portions are not limited to three, but two or four stepped portions may be provided in each of the step groups, wherein each of the stepped portions has the different height from that of the other stepped portion(s). In other words, multiple stepped portions having different heights of any optional number may be provided, so long as one of them can be selected when the swaged claw is formed.

In addition, in the above embodiments, the multiple stepped portions 31, 32 and 33 (71b, 72b, 73b or 71c, 72c, 73c) are provided in each of the three step groups in the circumferential direction. The number of the step groups is not limited to three, but two or more than three step groups may be provided.

(M3) The structure of the adjust screw member 40a in the second embodiment is one of examples for the adjust screw member. The present disclosure is not limited to the structure of the second embodiment but can be modified in various manners. For example, in the second embodiment, the first inclined portions “α” and the second inclined portions “β” are continuously arranged in the circumferential direction. However, the first inclined portions “α” and the second inclined portions “β” may be intermittently arranged in the circumferential direction.

In addition, in the circumferential area, in which the top portion between the first inclined portions “α” and the second inclined portions “β” is not formed, the swaged claw 60 may be formed. In this case, it is preferable that one of the first inclined portions “α” is pressed by one of the swaged claws 60 in the first axial direction, while one of the second inclined portions “β” is pressed by another one of the swaged claws 60 in the first axial direction. According to such a modified structure, the same advantages to those of the second embodiment can be obtained.

(M4) The spring load adjusting device 10, 10b, or 10c is applied to the spool valve unit 80 of the linear solenoid valve 100, wherein the spool valve unit 80 is operated by the electromagnetic unit 90 (a driving portion for the spool valve unit 80). However, an actuator of any other type, a pilot device of a hydraulic type or the like may be used as the driving portion for the spool valve unit 80.

In addition, the present disclosure is not limited to the spool valve unit 80 for controlling the oil pressure of the working oil to be supplied to the automatic transmission apparatus for the automotive vehicle. For example, the present disclosure may be applied to any type of the spool valve unit, for which the high sealing property is required between a first member (for example, the sleeve member 81) and a second member (for example, the adjust screw member 40, 40a, 40b or 40c). Furthermore, the present disclosure may be applied to any type of the valve device, in which the high sealing property is required between a first member (for example, the female screw member 20) and a second member (for example, the adjust screw member 40, 40a, 40b or 40c).

The present disclosure is not limited to the above embodiments and/or modifications but can be further modified in various manners without departing from a spirit of the present disclosure.

What is claimed is:

1. A spring load adjusting device for a valve device having a sleeve member, a spool member movably accommodated in the sleeve member, and a spring member for biasing the spool member in an axial direction of the valve device comprising:
a female screw member of a cylindrical shape having a female screw formed at an inner peripheral surface of the female screw member, the female screw member having a swaged-claw forming portion formed at an axial end of the female screw member;
an adjust screw member having a male screw formed at an outer peripheral surface of the adjust screw member, the male screw being engaged with the female screw and an axial position of the adjust screw member relative to the female screw member being changed by rotating the adjust screw member with respect to the female screw member to thereby adjust a spring load of the spring member to be applied to the spool member; and
multiple swaged claws, each of which is formed by plastically deforming a part of the swaged-claw forming portion,
wherein the adjust screw member is pressed by the swaged claws in the axial direction to the spool member, when the part of the swaged-claw forming portion is swaged to an axial end surface of the adjust screw member,
wherein multiple stepped portions are formed in the swaged-claw forming portion and/or the axial end surface of the adjust screw member, and
wherein each of the stepped portions has a height different from one another in the axial direction, so that an axial distance between the swaged-claw forming portion and axial end surface of the adjust screw member is different from a position of one stepped portion to a position of another stepped portion.

2. The spring load adjusting device according to claim 1, wherein
the multiple stepped portions are formed in the swaged-claw forming portion formed at the axial end of the female screw member.

3. The spring load adjusting device according to claim 1, wherein
the multiple stepped portions are formed in the axial end surface of the adjust screw member.

4. The spring load adjusting device according to claim 1, wherein
the axial end surface of the adjust screw member includes;
a first inclined portion for applying a rotational force to the adjust screw member in a screw fastening direction, when a press force is applied by the swaged claw to the first inclined portion in the axial direction; and
a second inclined portion for applying a rotational force to the adjust screw member in a screw unfastening direction, when a press force is applied by the swaged claw to the second inclined portion in the axial direction.

5. A method for adjusting a spring load for a valve device, which comprises;
a sleeve member;
a spool member movably accommodated in the sleeve member;
a spring member for biasing the spool member in an axial direction of the valve device; and
a spring load adjusting device including;
a female screw member of a cylindrical shape having a female screw formed at an inner peripheral surface of the female screw member, the female screw member having a swaged-claw forming portion formed at an axial end of the female screw member;
an adjust screw member having a male screw formed at an outer peripheral surface of the adjust screw member, the male screw being engaged with the female screw; and
multiple stepped portions formed in the swaged-claw forming portion and/or an axial end surface of the adjust screw member, wherein each of the stepped portions has a height different from one another in the axial direction, so that an axial distance between the swaged-claw forming portion and the axial end surface of the adjust screw member is different from a position of one stepped portion to a position of another stepped portion,
wherein the method for adjusting the spring load includes;
a step for adjusting the spring load by adjusting an axial position of the adjust screw member relative to the female screw member;
a step for selecting one of the stepped portions depending on the axial distance between the swaged-claw forming portion and the axial end surface of the adjust screw member; and
a step for plastically deforming a part of the swaged-claw forming portion of the selected stepped portion to form a swaged claw swaged to the axial end surface of the adjust screw member, wherein the adjust screw member is pushed by the swaged claw in the axial direction to the spring member.
